(19) United States
(12) Patent Application Publication
(10) Pub. No.: US 2012/0278661 A1
(43) Pub. Date: Nov. 1, 2012

(54) HARD DISK BACKPLANE AND HARD DISK MONITORING SYSTEM

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/170,176

(22) Filed: Jun. 27, 2011

(30) Foreign Application Priority Data
Apr. 27, 2011 (CN) 201110106349.X

(51) Int. Cl. G06F 11/16

(52) U.S. Cl. 714/39; 714/47.1; 714/E11.062

(57) ABSTRACT

A hard disk backplane for supporting a number of hard disks includes a display unit for displaying the present status of the hard disks, and a programmable logic chip. The display unit includes at least one seven segment LED display. The status displayed includes an indication of a normal working or an indication otherwise for abnormal working. The programmable logic chip is configured for obtaining signals as to the present status of the plurality of hard disks, and driving the at least one seven segment LED display to display the status based on the signals.

### BACKGROUND

1. Technical Field

The present disclosure relates to a hard disk backplane with digital display function and a hard disk monitoring system having such a hard disk backplane.

2. Description of Related Art

Many computers include a number of hard disks for increasing storage capacity and a hard disk backplane for supporting the hard disks and electrically connecting the hard disks to a CPU. When there is a hard disk problem, a loudspeaker of the hard disk backplane produces a warning sound or an indicator light flashes a warning.

However, where there are a multiple of hard disks on a computer, the said warning usually leaves the user confused because the user cannot quickly establish which hard disk is experiencing the problem. Accordingly, the problem needs time to be solved, and working efficiency decreases.

Therefore, what is needed is a new hard disk backplane and a hard disk monitoring system having such hard disk backplane which overcomes the described limitations.

### BRIEF DESCRIPTION OF THE DRAWINGS

FIG. 1 is a block diagram of a hard disk monitoring system according to an exemplary embodiment.

FIG. 2 is a block diagram of a programmable logic chip of the hard disk monitoring system of FIG. 1.

### DETAILED DESCRIPTION

Embodiments will be described in detail with reference to the drawings.

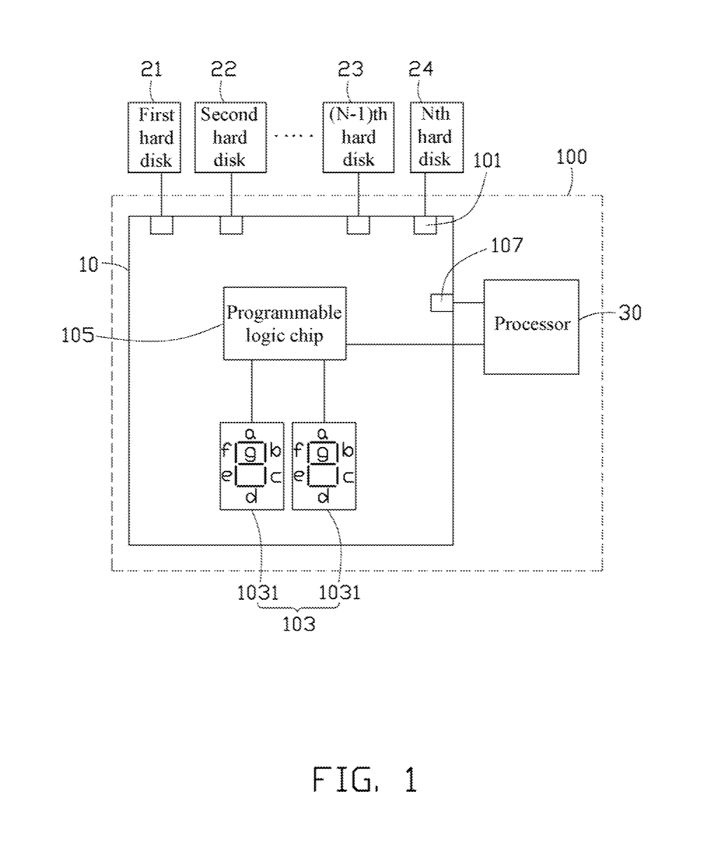

Referring to FIG. 1, a hard disk monitoring system 100 includes a hard disk backplane 10 and a processor 30 electrically connected to the hard disk backplane 10. The hard disk monitoring system 100 is configured for monitoring the status of a plurality of hard disks (e.g. a first hard disk 21, a second hard disk 22 . . . an (N−1)th hard disk 23, and an Nth hard disk 24, (where N is an integer greater than 4)) arranged on the hard disk backplane 10. Each hard disk is electrically connected to the hard disk backplane 10 via a plurality of interfaces 101.

In the present embodiment, the hard disk backplane 10 is a SATA hard disk backplane, the hard disks are SATA hard disks, and the interfaces 101 are SATA interfaces. In other embodiments, the hard disk backplane 10 may be a SCSI hard disk backplane, an IDE hard disk backplane, or similar. In any such case, the hard disks would be a corresponding type of hard disk.

The hard disk backplane 10 includes a display unit 103 and a programmable logic chip 105 electrically connected to the display unit 103.

The display unit 103 is configured for displaying the status of the hard disks. The display unit 103 includes at least one seven segment LED display 1031 which includes LED segments a, b, c, d, e, f, and g. The at least one seven segment LED display 1031 displays the status of the hard disks according to preset display parameters. The status displayed includes indications of a normal working status and an abnormal working status if one of the hard disks is not working normally. In the present embodiment, there are two seven segment LED displays 1031.

The programmable logic chip 105 is electrically connected to the processor 30 via an interface 107 on the hard disk backplane 10. The programmable logic chip 105 is configured for obtaining data concerning the present status of the hard disks from the processor 30, and driving the display unit 103 to display the status of the hard disks based on the data obtained. In the present embodiment, the programmable logic chip 105 is a chip capable of recognizing and distinguishing an SGPIO signal.

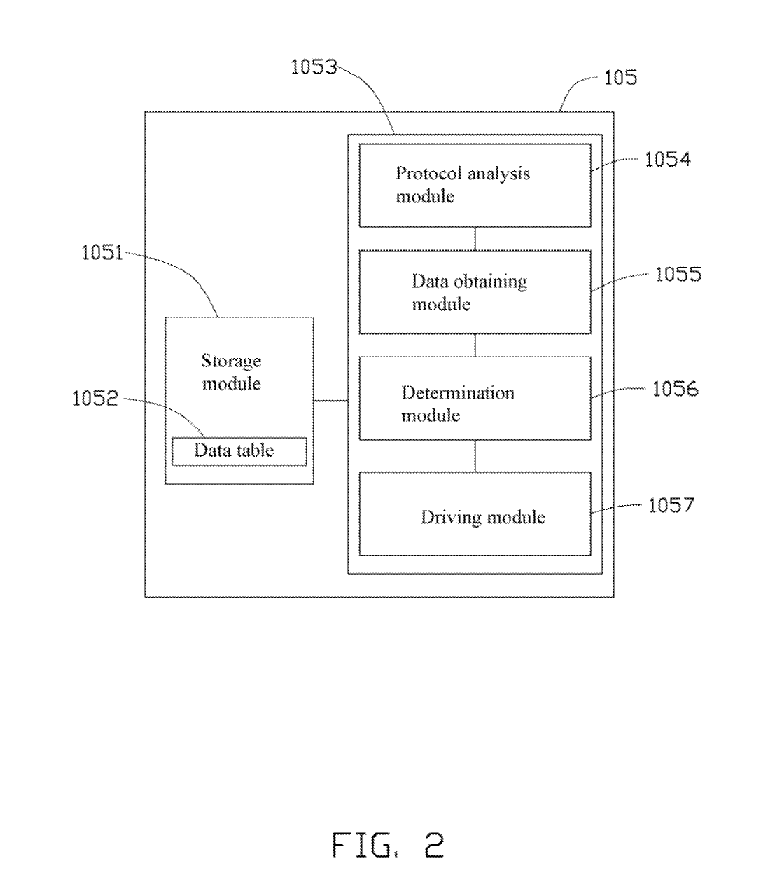

Referring to FIG. 2, the programmable logic chip 105 includes a storage module 1051 and a control unit 1053 electrically connected to the processor 30 via the interface 107 for controlling the display unit 103. In controlling the display unit 103, when the control level is a high logic level (logic 1), then the LED is on, and when the control level is a low logic level (logic 0), the LED is off. For example, when the two seven segment LED displays 1031 display “02”, the controlling logic value is “1111110-1101101”. In other embodiments, the LED is on when the control level is a low logic level (logic 0), and off when the control level is a high logic level (logic 1). In such a case, when the two seven segment LED displays display “02”, the controlling logic value is “0000001-0010010”.

The storage module 1051 is electrically connected to the control unit 1053, and includes a data table 1052. The data table 1052 includes a plurality of preset effective data and a plurality of corresponding preset controlling logic values for the display 1031.

The control unit 1053 includes a protocol analysis module 1054, a data obtaining module 1055 electrically connected to the protocol analysis module 1054, a determination module 1056 electrically connected to the data obtaining module 1055, and a driving module 1057 electrically connected to the determination module 1056.

The protocol analysis module 1054 is configured for analyzing status signals from the processor 30 in real time based on a SGPIO protocol, and determining an effective data in the signals.

The data obtaining module 1055 is configured for obtaining the effective data from the protocol analysis module 1054, and transmitting the same to the determination module 1056.

The determination module 1056 is configured for determining the effective data from the data obtaining module 1055, and finding corresponding a controlling logic value for the display 1031, and transmitting the controlling logic value to the driving module 1057.

The driving module 1057 is configured for driving the at least one display 1031 to display an indication of normal working, or display an indication of abnormal working.

The processor 30 is electrically connected to the programmable logic chip 105, and electrically connected to the hard disks via the interface 107 and the interfaces 101. The processor 30 obtains instant data as to the functioning of each of the hard disks (i.e first real time status signals) from the hard disks via the interface 107 and the interfaces 101, and converts the first real time status signals to second real time status signals capable of being recognized and distinguished by the programmable logic chip 105, and transmits the second real time status signals to the programmable logic chip 105. In the present embodiment, the processor 30 is a host bus adapter. In other embodiments, the processor 30 may be a disk array controller, or other device capable of functioning as aforesaid. In the present embodiment, the first real time status signals are SATA signals, and the second real time status signals are SGPIO signals. In other embodiments, the first real time status signals may be SAS signals, SCSI signals, IDE signals, or other signals of a different type.

In one exemplary embodiment, there are twenty hard disks used as an example here. When the display unit 103 displays “00”, it signifies that all of the twenty hard disks are working normally. When the display unit 103 displays “01”, it means that there is a problem with the first hard disk 21. When “02” is displayed, it means that there is a problem with the second hard disk 22. When the display unit 103 displays “03”, it means that there is a problem with the third hard disk. And so on and so forth, when the display unit 103 displays “19”, it means that there is a problem with the nineteenth hard disk 23. When the display unit 103 displays “20”, it means that there is a problem with the twentieth hard disk 24.

As an example using the second hard disk 22 which has a problem, a working process of the programmable logic chip 105 would proceed as follows.

For clearly showing the data table 1052, table 1 is shown. The data in the table 1 can be changed by the user based on his/her requirements.

TABLE 1

| | effective data | | |
|---|---|---|---|
| | 0000 | 0010 | 0011 |
| controlling logic value | 1111110-1111110 | 1111110-1101101 | 1111110-1111001 |
| (abcdefg-abcdefg) | | | |

It is clear that although there are only three groups of effective data and their corresponding controlling logic values, the other seventeen groups of effective data and the corresponding logic values can be established by analogy in this embodiment (which describes twenty hard disks).

The processor 30 transmits a second real time status signal to the protocol analysis module 1054, signifying a problem with the second hard disk 22. The second real time status signal includes an effective data “0010”, which means that there is a problem with the second hard disk 22.

The protocol analysis module 1054 analyzes the second real time status signal from the processor 30 based on an SGPIO protocol, and evaluates the effective data is “0010”.

The data obtaining module 1055 obtains the effective data “0010” from the protocol analysis module 1054, and transmits the effective data “0010” to the determination module 1056.

The determination module 1056 receives the effective data “0010” from the data obtaining module 1055, and determines that the matching controlling logic value is “1111110-1101101” of the at least one seven segment LED display 1031, which corresponds to the effective data “0010”, and transmits the controlling logic value “1111110-1101101” to the driving module 1057.

The driving module 1057 feeds the display 1031 to display “02”, to show that there is a problem with the second hard disk 22. In alternative embodiments, the effective data “0000” may correspond to the controlling logic value “1111110-1101101”, the controlling logic value “1000111-1111001”, the controlling logic value “1000111-0110111”, etc. In such cases, the display unit 103 may display the corresponding “02”, “F3”, “FH”, or other character(s) to show that the hard disks are working normally. In further alternative embodiments, the effective data “0010” may correspond to the controlling logic value “1111110-1111110”, the controlling logic value “1000111-1111001”, or the controlling logic value “1000111-0110111”, ect. In such cases, the display unit 103 may display the corresponding “00”, “F3”, “FH” or other number or character to show that there is a problem with the second hard disk 22.

When the number of the hard disk 22 is equal to or less than 9, only one seven segment LED display 1031 may be required to display the real time status of the hard disks. In such a case, the display unit 103 can display the real time status of each of the hard disks based on preset display information (e.g. 1, 3, A, H or other number, character(s).

The hard disk backplane 10 displays the real time status of the hard disks via the at least one seven segment LED displays 1031. Accordingly, the user knows instantly that there is a problem with a hard disk, and the identity of the malfunctioning disk is also revealed, by viewing the numbers or characters displayed by the at least one seven segment LED displays 1031. The problem can thus be solved quickly, and working efficiency can thus be improved.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A hard disk backplane for supporting a plurality of hard disks, comprising:
a display unit for displaying a status of the plurality of hard disks, the display unit comprising at least one seven segment LED display, the status displayed comprising indications of a normal working status and an abnormal working status if one of the hard disks is not working normally; and
a programmable logic chip for gaining status signals of the plurality of hard disks, and driving the at least one seven segment LED display to display the real time status based on the status signals.

2. The hard disk backplane of claim 1, wherein the programmable logic chip comprises a data table and a control unit, the data table comprises a plurality of preset effective data and a plurality of corresponding preset logic values for the at least one seven segment LED display, the control unit is configured for controlling the display unit to display the status, the control unit comprises:
a protocol analysis module for analyzing the status signals from the processor, and determining an effective data from the status signals;
a data obtaining module for obtaining the effective data from the protocol analysis module;
a determination module for receiving the effective data from the data obtaining module, and finding a controlling logic value for the at least one seven segment LED display in the data table, which is corresponding to the effective data, and
a driving module for driving the at least one seven segment LED display to display the status based on the controlling logic value for the at least one seven segment LED display.

3. The hard disk backplane of claim 1, wherein the number of the plurality of hard disks is less than or equal to 20, and the number of the at least one seven segment LED display is two.

4. The hard disk backplane of claim 1, wherein the number of the plurality of hard disks is less than or equal to 9, and the number of the at least one seven segment LED display is one.

5. A hard disk monitoring system for monitoring a real time status of a plurality of hard disks, comprising:
a hard disk backplane comprising:
a display unit for displaying a status of the plurality of hard disks, the display unit comprising at least one seven segment LED display, the status displayed comprising a normal working status and an abnormal working status if one of the plurality of hard disks is working abnormally, and
a programmable logic chip, and
a processor electrically to the hard disk backplane and the plurality of hard disks, the processor being configured for gaining first real time status signals of the hard disks from the hard disks, converting the first real time status signals to second real time status signals capable of being distinguished by the programmable logic chip, and transmitting the second real time status signals to the programmable logic chip, the programmable logic chip gaining the second real time status signals form the processor, and driving the at least one seven segment LED display to display the real time status based on the second real time status signals.

6. The hard disk monitoring system of claim 5, wherein the second real time signals from the processor are SGPIO signals.

7. The hard disk monitoring system of claim 5, wherein the programmable logic chip comprises a data table and a control unit, the data table comprises a plurality of presetting effective data and a plurality of corresponding presetting logic values for the at least one seven segment LED display, the control unit is configured for controlling the display unit to display the status, the control unit comprises:
a protocol analysis module for analyzing status signals from the plurality of hard disks, and determining an effective data from the status signals;
a data obtaining module for obtaining the effective data from the protocol analysis module;
a determination module for determining the effective data, and finding corresponding controlling logic value for the at least one seven segment LED display in the data table, and
a driving module for driving the at least one seven segment LED display to display the status based on the controlling logic value for the at least one seven segment LED display.
